(19) United States
(12) Patent Application Publication
(10) Pub. No.: US 2026/0219686 A1
(43) Pub. Date: Jul. 30, 2026

(54) BOUNDARY LINE IDENTIFICATION METHOD, INTELLIGENT DEVICE, AND NON-TRANSITORY COMPUTER READABLE STORAGE MEDIUM

(71) Applicant: JIANGSU DONGCHENG M&E TOOLS CO., LTD., NANTONG, JIANGSU (CN)

(72) Inventor: DONGHUI ZHU, NANTONG, JIANGSU (CN)

(21) Appl. No.: 19/143,923

(22) PCT Filed: Sep. 25, 2024
(86) PCT No.: PCT/CN2024/121018

§ 371 Date: Jun. 27, 2025

(30) Foreign Application Priority Data
Oct. 12, 2023 (CN) 202311321449.3

(51) Int. Cl. G05D 1/648; A01D 34/00; A01D 101/00; G05D 1/246; G05D 1/644; G05D 107/20; G05D 109/10; G05D 111/30

(52) U.S. Cl. CPC G05D 1/6484; A01D 34/008; G05D 1/246; G05D 1/644; A01D 2101/00; G05D 2107/23; G05D 2109/10; G05D 2111/36

(57) ABSTRACT

The present disclosure provides a boundary line identification method, an intelligent device and a non-transitory computer readable storage medium. The boundary line identification method includes detecting a target signal, where the target signal is generated from a boundary line of a working area, and the boundary line includes an inner boundary line and an outer boundary line; obtaining the identity information embedded in the target signal, and marking, in condition of not finding the identity information of the inner boundary line or the outer boundary line the database that matches with the identity information embedded in the target signal, the current boundary line as the inner boundary line. The identity information embedded in the target signal is configured to indicate whether a current boundary line belongs to the outer boundary line or the inner boundary line of the working area.

### CROSS REFERENCE TO RELATED APPLICATIONS

This application is a 35 U.S.C. § 371 National Phase conversion of International (PCT) Patent Application No. PCT/CN 2024/121018 filed on Sep. 25, 2024, which claims foreign priority to Chinese Patent Application No. 202311321449.3, filed on Oct. 12, 2023, the contents of all of which are hereby incorporated by reference.

### TECHNICAL FIELD

The present disclosure relates to the technical field of intelligent machinery and device, and in particular, to a boundary line identification method, an intelligent device and a non-transitory computer readable storage medium.

### BACKGROUND

With the development of science and technology, intelligent self-moving devices have become well-known. Since these self-moving devices can automatically execute pre-set tasks according to pre-programmed instructions without human operation or intervention, they have been widely applied in industrial and household products. Industrial applications such as robots performing various functions, and household products such as lawn mowers, vacuum cleaners, etc., have greatly saved time and brought tremendous convenience to both industrial production and home life.

In application, intelligent self-moving walking devices need to identify and determine a working area. Typically, within the working area, there may be islands where the intelligent self-moving walking device cannot or should not operate. For example, a robotic mower works on the lawn that needs to be trimmed with flower beds, ornamental ponds, and other areas on the lawn that do not need to be trimmed. These flower beds, ornamental ponds, etc., thus form islands, and a boundary line surrounding the island is referred to as the inner boundary line.

Currently, the identification of the island is achieved by controlling the intelligent device to track the boundary line, and then determining whether the tracked boundary line is an outer boundary line or an inner boundary line based on accumulated information from a wheel odometry. For the intelligent device to identify whether the boundary line is the outer or inner boundary line, it often requires the intelligent device to travel around the working area at least once, which affects the efficiency of identification of the boundary line and results in a low accuracy in identifying the inner boundary line.

### SUMMARY

In order to solve the above technical problems, the present disclosure provides a boundary line identification method.

In order to realize the above objectives, the technical solutions provided by the present disclosure are as follows.

The present disclosure provides a boundary line identification applied to a self-moving intelligent device, including:
detecting a target signal, wherein the target signal is generated from a boundary line of a working area, and the boundary line comprises an inner boundary line and an outer boundary line;
obtaining identity information embedded in the target signal from a database, wherein the database stores at least one identity information of the inner boundary line, the identity information embedded in the target signal is configured to indicate whether a current boundary line belongs to the outer boundary line or the inner boundary line of the working area, the target signal is emitted by an electronic tag on the current boundary line, and the electronic tag is at least disposed on the inner boundary line;
marking, in condition of not finding the identity information of the inner boundary line or the outer boundary line in the database that matches with the identity information embedded in the target signal, the current boundary line as the inner boundary line.

In a second aspect, the present disclosure provides an intelligent device, wherein the intelligent device includes a detection module and a marking module;
the detection module is configured to detect a target signal, the target signal is generated from a boundary line of a working area, and the boundary line comprises an inner boundary line and an outer boundary line;
the marking module is configured to obtain identity information embedded in the target signal, a database stores at least one identity information of the inner boundary line, the identity information embedded in the target signal is configured to indicate whether a current boundary line belongs to the outer boundary line or the inner boundary line of the working area, the target signal is emitted by an electronic tag on the current boundary line, and the electronic tag is at least disposed on the inner boundary line
in condition of not finding the identity information of the inner boundary line or the outer boundary line in the database that matches with the identity information embedded in the target signal, the current boundary line is marked as the inner boundary line and the database is updated

The present disclosure further provides a non-transitory computer readable storage medium. The non-transitory computer readable storage medium stores an instruction, which when executed by a processor, implements the method of
detecting a target signal, wherein the target signal is generated from a boundary line of a working area, and the boundary line comprises an inner boundary line and an outer boundary line;
obtaining identity information embedded in the target signal from a database, wherein the database stores at least one identity information of the inner boundary line, the identity information embedded in the target signal is configured to indicate whether a current boundary line belongs to the outer boundary line or the inner boundary line of the working area, the target signal is emitted by an electronic tag on the current boundary line, and the electronic tag is at least disposed on the inner boundary line;
marking, in condition of not finding the identity information of the inner boundary line or the outer boundary line in the database that matches with the identity information embedded in the target signal, the current boundary line as the inner boundary line.

### BRIEF DESCRIPTION OF THE DRAWINGS

In order to more clearly illustrate the technical solutions of the embodiments of the present disclosure, a brief introduction to the drawings required in the description of the embodiments will be provided below. It is evident that the drawings described below are merely some embodiments of the present disclosure, and those skilled in the art can, without any creative effort, obtain other drawings based on these drawings.

FIG. 1 is a flowchart of a boundary line identification method of the present disclosure;

FIG. 2 is a flowchart of a boundary line identification method of the present disclosure;

FIG. 3 is a flowchart of a boundary line identification method of the present disclosure;

FIG. 4 is a flowchart of a boundary line identification method of the present disclosure;

FIG. 5 is a flowchart of a boundary line identification method of the present disclosure;

FIG. 6 is a flowchart of a boundary line identification method of the present disclosure;

FIG. 7 is a flowchart of a boundary line identification method of the present disclosure;

FIG. 8 is a schematic view of a working area of the present disclosure.

FIG. 9 is a schematic view of a wiring of inner and outer boundary lines of the present disclosure.

FIG. 10 is a schematic view of ta direction of a boundary line of the present disclosure.

### DETAILED DESCRIPTION

In order to make the objectives, technical solutions, and advantages of the embodiments of the present disclosure clearer, the technical solutions of the embodiments of the present disclosure will be described in detail below as shown in the accompanying drawings of the present disclosure. It is evident that the described embodiments are only part of the embodiments of the present disclosure, and not all of them. Any other embodiments derived by those skilled in the art based on the described embodiments of the present disclosure without creative effort should within the scope of protection of the present disclosure.

Unless otherwise defined, the technical terms or scientific terms used in the present disclosure should be understood in their ordinary meaning by those skilled in the art to which the present disclosure pertains. The words “a”, “an”, or “the” and similar terms used in the present disclosure do not indicate a limitation on quantity, but rather mean “at least one”. The words “comprising” or “including” and similar terms indicate that the elements or objects listed after the word are included, along with their equivalents, but do not exclude other elements or objects.

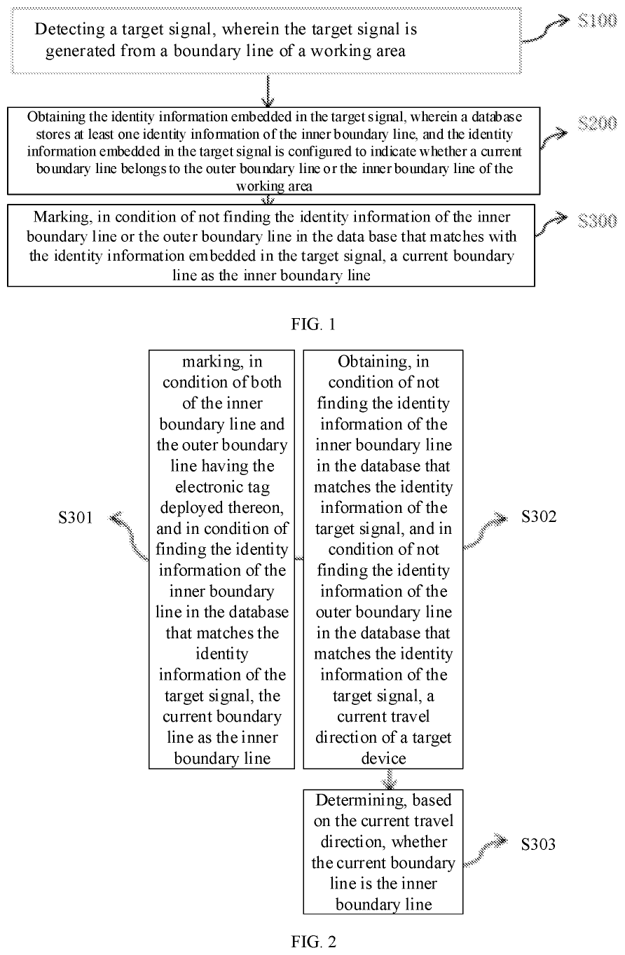

As shown in FIG. 1, a boundary line identification method provided by the present disclosure, applied to self-moving intelligent devices, includes operations executed by the following blocks.

At block S100, a target signal is detected, where the target signal is generated from a boundary line of a working area, and the boundary line includes an inner boundary line and an outer boundary line.

At block S200, identity information embedded in the target signal is obtained, where a database stores at least one identity information of the inner boundary line, the identity information embedded in the target signal is configured to indicate whether a current boundary line belongs to the outer boundary line or the inner boundary line of the working area, the target signal is emitted by an electronic tag on the current boundary line, and the electronic tag is at least disposed on the inner boundary line.

At block S300, in condition of not finding the identity information of the inner boundary line or the outer boundary line in the database that matches with the identity information embedded in the target signal, the current boundary line is marked as the inner boundary line.

The present disclosure, by detecting the target signal generated in the boundary line and obtaining the identity information embedded in the target signal, marks the current boundary line as the inner boundary line. After detecting the target signal, the intelligent device follows the current boundary line. Since an electronic tag is set on the inner boundary line, a reader set in the intelligent device may read ID information of the electronic tag and compare it with inner tag information data stored in the intelligent device. Thus, the intelligent device may identify whether the current boundary line being tracked is the inner boundary line. As a result, there is no need to travel around the boundary line to determine the inner and outer boundary lines through walking direction or wheel odometry, thus improving identification efficiency and accuracy and reducing the cost of identification.

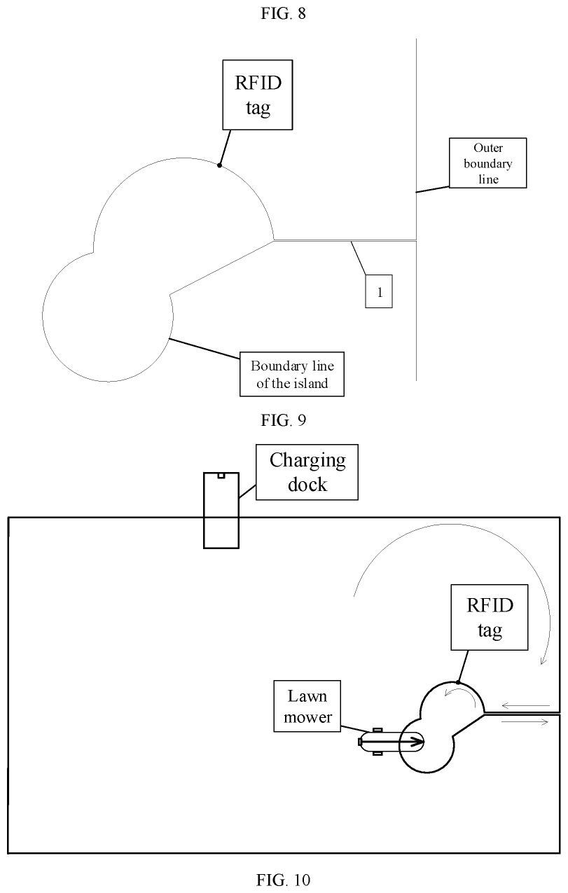

It should be noted that, as shown in FIGS. 8 to 10, the above boundary line identification method is applied to a self-moving walking and working intelligent device 10. The intelligent device includes an automatic delivery robot, a water delivery robot, a smart vacuum cleaner, a smart floor cleaning robot, a smart robotic mower, and other intelligent machines capable of self-moving movement, path identification, and work area planning. The technical solution of the present disclosure is illustrated using a smart robotic mower as an example for the purpose of description, which is not limited to the smart robotic mower.

The smart robotic mower, or also referred to as an outdoor robotic mower, extends a cable from a charging dock. The cable is placed along the boundary of the working area of the mower, known as the outer boundary line. A signal transmitter of the charging station energizes the cable, generating a magnetic field along the outer boundary line. A boundary sensor (inductive coil) of the mower may detect the magnetic field, thereby detecting the outer boundary line. Fixed obstacles within the working area, such as flower beds or water ponds, may be surrounded by the same cable to form the inner boundary line, thus enclosing the obstacles.

At block S100, the target signal may be understood as a boundary line signal. The boundary line is formed by surrounding a boundary of the working area with a cable, which generates an electromagnetic signal when energized. Alternatively, the target signal may also be a radio frequency (RF) signal or a Wireless Fidelity (Wi-Fi) signal emitted by the electronic tag set on the boundary line, or any other signals that may be distinct from the electromagnetic signal generated by the boundary line. The type of signal may also be distinguished by identifying whether it is the electromagnetic signal emitted by the boundary line or the signal emitted by the electronic tag.

The inner boundary line is arranged to surround the inner boundary and the outer boundary is arranged to surround an outer periphery of the working area, thereby separating the inner and outer boundaries. After the intelligent device detects the boundary line signal, the intelligent device follows the current boundary line. An electronic tag, such as a Radio Frequency Identification (RFID) tag, may be set on the inner boundary line. The reader set in the intelligent device may read the ID information of the electronic tag and compare it with the inner tag information data stored in the intelligent device. Thus, the intelligent device may identify whether the current boundary line being tracked is the inner boundary line. Since only one tag is set on the inner boundary line, it not only reduces costs but also improves identification efficiency. Furthermore, during the process of tracking the boundary line, when the RF signal of the electronic tag is detected, it may be compared and identified with a list of inner tags stored in a memory. The intelligent device does not need to walk around both the inner and outer boundaries to determine the boundary based on the odometry, thus improving the accuracy and efficiency of identification.

In the case of mowing along the outer boundary line and returning to the charging station for recharging, the smart robotic mower needs to walk along the outer boundary line to mow, weed, or guide itself back to the charging dock of the charging station. Since the inner and outer boundary lines use the same cable, it is necessary to distinguish between the inner and outer boundary lines.

At blocks S200 and S300, in condition of both of the inner boundary line and the outer boundary line having the electronic tag disposed thereon, in the case where the electronic device initializes and establishes a database to store the boundary line identity information, the following steps may be included. The outer boundary line of the working area is traversed. In condition of detecting the target signal emitted by the electronic tag disposed on the outer boundary line, the target signal is parsed to obtain the identity information of the outer boundary line, which is then stored in the database. Based on the initialized database, which only stores the identity information of the outer boundary line, the device moves again in the working area, detecting the target signal of the electronic tag again. The target signal is parsed to obtain the identity information of the current boundary line. In condition of the identity information of the current boundary line being different from that of the outer boundary line being stored in the database, the current boundary line is determined as the inner boundary line.

At blocks S200 and S300, in condition of only the inner boundary line having the electronic tag disposed thereon, in the case where the intelligent device initializes and establishes a database to store the boundary line identity information, the following steps may be included. The outer boundary line of the working area is traversed, but the target signal emitted by the electronic tag disposed on the inner boundary line cannot be detected, and at this time, the database has not stored the identity information of the boundary line. Based on the initialized database, which does not store the identity information of the inner boundary line, the device moves again in the working area, detecting the target signal of the electronic tag again. The target signal is parsed to obtain the current boundary line of the target signal. In condition of not finding the identity information of the current boundary line in the database, the current boundary line is determined as the inner boundary line.

At blocks S200 and S300, in condition of only the inner boundary line having the electronic tag disposed thereon, after detecting the ID information of the electronic tag, the intelligent device may identify that the current boundary line being tracked is the inner boundary line. The database stores the identity information of the inner boundary. After detecting the ID information of the electronic tag, the intelligent device compares the current identity information with the identity information of the inner boundary line in the database. In a case where they match, the current boundary line is determined to be the inner boundary line. In a case where they cannot be matched, the current boundary line is identified as a new inner boundary line.

In order to improve the accuracy of current boundary line identification at block S300, the embodiments of the present application may also combine a travel direction, sensor detection data, sensor collision data, map data, or other data of the device, to comprehensively determine whether the current boundary line is the inner boundary line, thereby avoiding misidentification.

At block S300, in condition of the current boundary line being identified as the inner boundary line, it may be because the target signal of a historical electronic tag was not successfully identified, or it may be a first identification of a new electronic tag. In condition of the historical electronic tag being not successfully identified, a prompt message needs to be generated, indicating to check whether the electronic tag is faulty or whether the device used to detect the electronic tag is malfunctioning. In condition of being the first identification of the new electronic tag, the database information may be updated for easier identification next time, and a new map may also be generated based on the current boundary line, which helps with the map planning and navigation of the device.

In some embodiments, electronic tags are disposed on both the inner and outer boundary lines. After detecting the electronic tag signal, the identity information of the electronic tag is identified. By matching the current identity information with the identity information of the inner boundary line stored in the memory, in condition of the current identity information matching the identity information of the inner boundary line in the database, the current boundary line is identified as the inner boundary line. In condition of the current identity information matching the identity information of the outer boundary line in the database, the current boundary is identified as the outer boundary line. In condition of the current identity information not matching either the identity information of the inner boundary line or the identity information of the outer boundary line in the database, the current boundary line is identified as the inner boundary line. This effectively avoids the problem of the inner and outer boundaries cannot be distinguished from each other which is caused by the use of the same cable for the inner and outer boundaries, thereby not only reducing costs but also improving the identification accuracy.

In the above embodiments, the type of electronic tags may be the same, and the inner and outer boundaries may be laid using the same cable. As a result, the type of detector on the intelligent device may also be the same, avoiding the use of multiple types of detectors for detection, which may prevent the missed detection of tag signals and thus also save costs.

As shown in FIG. 2, in the above embodiments, before marking the current boundary line as the inner boundary line, the boundary line identification method, further includes operations executed by the following blocks.

At block S301, in condition of both of the inner boundary line and the outer boundary line having the electronic tag disposed thereon, and in condition of finding the identity information of the inner boundary line in the database that matches the identity information embedded in the target signal, the current boundary line is marked as the inner boundary line.

At block S302, in condition of not finding the identity information of the inner boundary line in the database that matches the identity information embedded in the target signal, and in condition of not finding the identity information of the outer boundary line in the database that matches the identity information embedded in the target signal, a current travel direction of a target device is obtained. The current travel direction refers to a direction of travel after moving a preset angle from a position of the current electronic tag.

At block S303, based on the current travel direction, the current boundary line is determined whether or not to be the inner boundary line.

At block S301, both the inner and outer boundary lines are disposed with electronic tags. The electronic tags on the inner and outer boundary lines may be set to the same type of tag. Since different types of electronic tags require different types of readers for detection, using the same type of electronic tag allows the same reader to detect them. This avoids the issue of missed detections caused by using different tags and also reduces the cost of purchasing different types of tags and readers.

Additionally, in condition of both of the inner boundary line and the outer boundary line having the electronic tag disposed thereon, and in condition of finding the identity information of the inner boundary line in the database that matches the identity information embedded in the target signal, the current boundary line is marked as the inner boundary line. In condition of both of the inner boundary line and the outer boundary line having the electronic tag disposed thereon, and in condition of finding the identity information of the outer boundary line in the database that matches the identity information embedded in the target signal, the current boundary line is marked as the outer boundary line.

At blocks S302 and S303, in order to save costs, electronic tags of the same type are set on both the inner and outer boundary lines. In condition of the not finding the identity information of the inner boundary line in the database that matches the identity information embedded in the target signal, and in condition of not finding the identity information of the outer boundary line in the database that matches the identity information embedded in the target signal, it becomes difficult to directly determine the type of the current boundary line. In this case, the detection of the travel direction is required to help determine whether the current boundary line is the inner boundary line or the outer boundary line. Since the boundary line generates a magnetic field when energized, and the inner and outer boundary lines are arranged to produce magnetic fields in different directions, the direction of the device travelling along the boundary line also differs. Conversely, the direction of the device travelling along the boundary line may be used to identify whether the current boundary line is the inner boundary line or the outer boundary line.

Therefore, the present disclosure may avoid the situation where the inner and outer boundaries use the same cable, the same type of cable and electronic tags, which would produce the same boundary signal, thus preventing the device from being unable to distinguish between the inner boundary line and the outer boundary line of the working area.

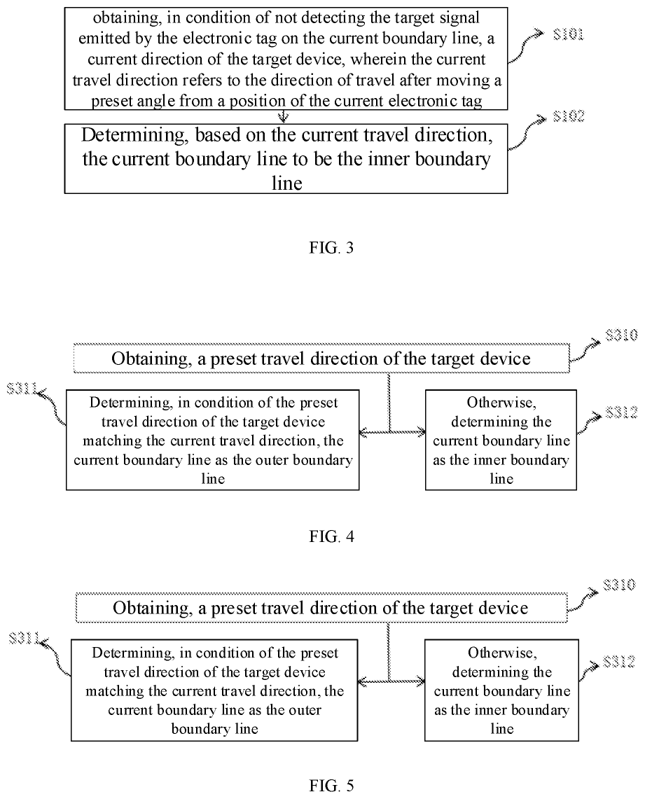

Unlike the above embodiments, as shown in FIG. 3, the boundary line identification method further includes operations executed by the following blocks.

At block S101, in condition of not detecting the target signal emitted by the electronic tag on the current boundary line, a current travel direction of the target device is obtained, and the current travel direction refers to the direction of travel after moving a preset angle from a position of the current electronic tag.

At block S102, based on the current travel direction, the current boundary line is determined whether or not to be the inner boundary line.

At block S101, when an electronic tag is not disposed on the current boundary line or the electronic tag being disposed is damaged or lost, or the electronic tag reader on the device has an error or malfunction, the target signal emitted by the electronic tag on the current boundary line may not be detected. In this case, it is necessary to combine the travel direction of the device.

At block S102, since the boundary line generates a magnetic field when energized, and the inner and outer boundary lines are arranged to produce magnetic fields in different directions, the direction of the device travelling along the boundary line also differs. Conversely, the direction of the device travelling along the boundary line may be used to identify whether the current boundary line is the inner boundary line or the outer boundary line.

In the above embodiments, as shown in FIG. 4, the determining whether the current boundary line is the inner boundary line based on the current travel direction includes operations executed by the following blocks.

At block S310, a preset travel direction of the target device is obtained.

At block S311, in condition of the preset travel direction of the target device matching the current travel direction, the current boundary line is determined as the outer boundary line.

At block S312, otherwise, the current boundary line is determined as the inner boundary line.

In some embodiments, as shown in FIG. 5, the method further includes operations executed by the following blocks.

At block S400, in condition of determining the current boundary line being the inner boundary line and the current device being not in an operation mode, an island map where the inner boundary line is located, the preset travel direction, and a preset travel path are obtained.

At block S500, based on the preset travel direction, a path along a boundary line of the island map is obtained and the preset travel path is updated.

At block S400, in condition of the not founding the identity information embedded in the current target signal in the database, the current boundary is identified as a new inner boundary line, the new inner boundary map is created, and the new inner boundary map is stored in the database, in condition of finding the identity information of the current boundary signal in the database, the inner boundary map stored in the database is directly read.

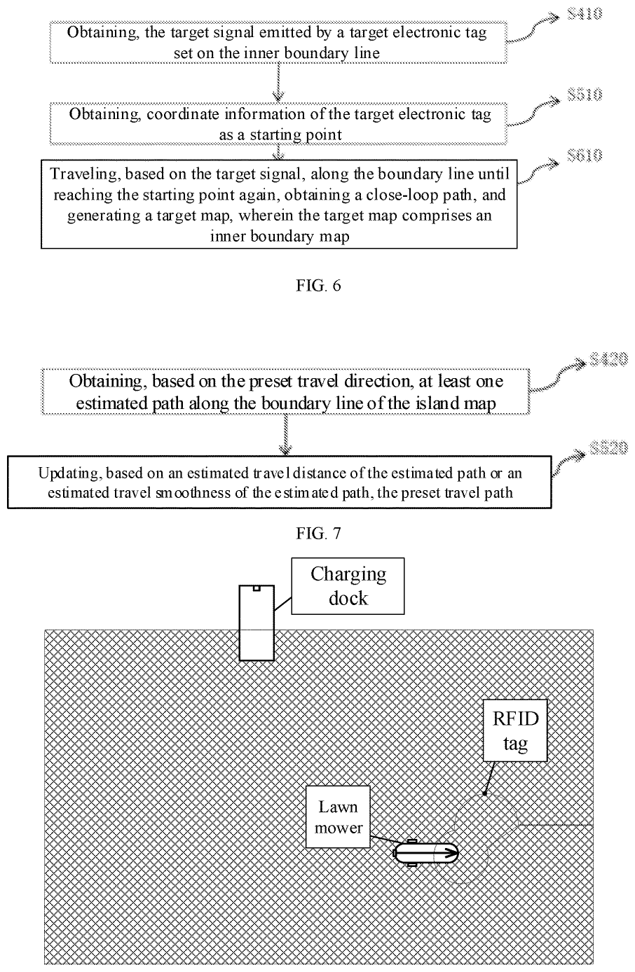

In the above embodiments, as shown in FIG. 6, the method further includes operations executed by the following blocks.

At block S410, the target signal emitted by a target electronic tag set on the inner boundary line is obtained.

At block S510, coordinate information of the target electronic tag is obtained as a starting point.

At block, S610, the boundary line is travelled along based on the target signal until the starting point is reached again, a close-loop path of is obtained, a target map is generated and the target map includes an inner boundary map.

At block S610, the inner boundary line is set with at least one electronic tag. To further improve efficiency and save costs, the inner boundary line may be set with only a single electronic tag, which allows for determining whether the current boundary line is the inner boundary line. After collecting the target signal, the device travels along the boundary line having the target signal. During the process of laying the inner and outer boundary lines, as shown in FIGS. 8 to 10, a conductive wire is first arranged around the inner boundary as the inner boundary line. At a predetermined position 1 of the inner boundary line, two opposing ends of the conductive wire are drawn out and arranged tightly and parallelly to cancel out the electromagnetic signal generated after energization. The conductive wire is then arranged outward, tightly and parallelly, until reaching the outer boundary of the working area, followed by one of the two opposing ends being arranged counterclockwise and another end being arranged clockwise around the outer boundary until the wire connects to the power supply. Therefore, the device cannot identify the boundary line signal where the two opposing ends of the conductive wire are tightly and parallelly arranged together. The inner and outer boundary lines identified by the device do not intersect, and the inner boundary line forms a closed-loop state. Following the inner boundary line, the device may not reach the outer boundary line, and following the outer boundary line, the device may not reach the inner boundary line.

Unlike the above embodiment, as shown in FIG. 7, the method further includes operations executed by the following blocks.

At block S420, based on the preset travel direction, at least one estimated path along the boundary line of the island map is obtained.

At block S520, based on an estimated travel distance of the estimated path or an estimated travel smoothness of the estimated path, the preset travel path is updated.

At block S420, updating the preset travel path means finding an optimal obstacle-avoidance path around the island. Therefore, among multiple preset paths around the boundary line of the island map, an obstacle-avoidance path that is the smoothest and shortest is selected. For example, paths from the starting point may include clockwise and counterclockwise directions. Information about different paths (road slope information or road material information), and distance information may be obtained to determine the optimal travel path.

Unlike the above embodiments, the method further includes operations executed by the following blocks.

At block S430, in condition of determining the current boundary line as the inner boundary line and the current device being in the operation mode, an operation path is obtained.

At block S530, based on the operation path, a travel path for leaving the inner boundary line is determined.

During operation in the working area, tasks are typically carried out based on a preset operation path. Generally, the operation path includes a “bow-shaped” path and a polygonal path. In the operation mode, the device may travel along the operation path to leave the inner boundary line.

Additionally, the present disclosure further provides an intelligent device 10, which is a self-moving device that uses any of the boundary line identification methods described in the above embodiments.

The intelligent device at least includes a detection module and a marking module.

The detection module is configured to detect the target signal, where the target signal is generated from the boundary line of the working area, and the boundary line includes the inner boundary line and the outer boundary line.

The marking module is configured to obtain the identity information embedded in the target signal, where the database stores at least one identity information of the inner boundary line. The target signal is emitted by the electronic tag on the current boundary line, and the electronic tag is disposed at least on the inner boundary line.

In condition of not finding the identity information of the inner boundary line or the outer boundary line in the database that matches with the identity information embedded in the target signal, the current boundary line is marked as the inner boundary line and the database is updated.

The above detection module and marking module may be configured to execute the boundary line identification method in any of the above embodiments, which will not be repeated here.

In the boundary line identification method and the intelligent device according to the embodiments of the present disclosure, after detecting the target signal, the intelligent device follows the current boundary line. Since an electronic tag is set on the inner boundary line, a reader set in the intelligent device may read the ID information of the electronic tag and compare it with the tag information data stored in the intelligent device.

Additionally, since only one electronic tag is set on the inner boundary line, it not only reduces costs but also improves identification efficiency. Furthermore, during the process of tracking the boundary line, when the RF signal of the electronic tag is detected, it may be compared and identified with the list of inner tags stored in the memory. The intelligent device does not need to travel around both the inner and outer boundaries before determining the boundary based on the odometry, thus improving identification accuracy and efficiency.

Moreover, the beacons on the inner and outer boundaries are of the same type, and the device only needs one sensor to detect the beacons. The inner and outer boundaries are surrounded along the same boundary line, and only one electronic tag (RFID) needs to be set at a position of the inner boundary, which is cost-effective, simple in design, and easy to implement.

The following points need to be explained:
(1) The drawings of the embodiments of the present disclosure only involve the structures related to the embodiments of the present disclosure. Other structures may refer to general designs.
(2) For clarity, in the drawings used to describe the embodiments of the present disclosure, the thickness of layers or regions is exaggerated or reduced. That is, these drawings are not drawn to scale.
(3) In the absence of conflicts, the embodiments and features of the embodiments of the present disclosure may be combined to form new embodiments.

The above are only some specific embodiments of the present disclosure, but the scope of the present disclosure is not limited thereto. The scope of protection of the present disclosure should be determined by the scope of the claims.

1-10. (canceled)

11. A boundary line identification method, applied to a self-moving intelligent device, comprising:
detecting a target signal, wherein the target signal is generated from a boundary line of a working area, and the boundary line comprises an inner boundary line and an outer boundary line;
obtaining identity information embedded in the target signal from a database, wherein the database stores at least one identity information of the inner boundary line, the identity information embedded in the target signal is configured to indicate whether a current boundary line belongs to the outer boundary line or the inner boundary line of the working area, the target signal is emitted by an electronic tag on the current boundary line, and the electronic tag is at least disposed on the inner boundary line;
marking, in condition of not finding the identity information of the inner boundary line or the outer boundary line in the database that matches with the identity information embedded in the target signal, the current boundary line as the inner boundary line.

12. The boundary line identification method as claimed in claim 11, wherein in condition of both of the inner boundary line and the outer boundary line having the electronic tag disposed thereon, before marking the current boundary line as the inner boundary line, the method further comprises:
traversing along the outer boundary line of the working area;
parsing, in condition of detecting the target signal emitted by the electronic tag disposed on the outer boundary line, the target signal to obtain the identity information of the outer boundary line and store the identity information of the outer boundary line in the database;
detecting, based on the database that stores the identity information of the outer boundary line, the target signal of the electronic tag again;
parsing the target signal to obtain the identity information of the current boundary line, and determining, in condition of the identity information of the current boundary line being different from that of the outer boundary line being stored in the database, the current boundary line as the inner boundary line.

13. The boundary line identification method as claimed in claim 11, wherein in condition of only the inner boundary line having the electronic tag disposed thereon, before marking the current boundary line as the inner boundary line, the method further comprises:
parsing, in condition of detecting the target signal emitted by the electronic tag, the target signal to obtain the identity information of the current boundary line;
determining, in condition of not finding the identity information of the current boundary line in the database, the current boundary line as the inner boundary line.

14. The boundary line identification method as claimed in claim 11, wherein, before marking the current boundary line as the inner boundary line, the method further comprises:
obtaining, in condition of not finding the identity information of the inner boundary line in the database that matches with the identify information embedded in the target signal and not finding the identity information of the outer boundary line that matches with the identity information embedded in the target signal, a current travel direction of a target device, wherein the current travel direction refers to a direction of travel after moving a preset angle from a position of current electronic tag, and the database stores at least one piece of identity information of the outer boundary line;
determining, based on the current travel direction, whether the current boundary line is the inner boundary line.

15. The boundary line identification method as claimed in claim 11, wherein the method further comprises:
obtaining, in condition of not detecting the target signal emitted by the electronic tag on the current boundary line, a current travel direction of a target device, wherein the current travel direction refers to a direction of travel after moving a preset angle from a position of a current electronic tag;
determining, based on the current travel direction, whether the current boundary line is the inner boundary line.

16. The boundary line identification method as claimed in claim 14, wherein the determining, based on the current travel direction, whether the current boundary line is the inner boundary line, comprises:
obtaining a preset travel direction of the target device;
determining, in condition of the preset travel direction of the target device being consistent with the current travel direction, the current boundary line as the outer boundary line;
otherwise, determining the current boundary line as the inner boundary line.

17. The boundary line identification method as claimed in claim 11, wherein the method further comprises:
obtaining, in condition of determining the current boundary line being the inner boundary line and a current device being not in an operation mode, an island map where the inner boundary line is located, a preset travel direction, and a preset travel path;
obtaining, based on the preset travel direction, a path along a boundary line of the island map and updating the preset travel path.

18. The boundary line identification method as claimed in claim 17, wherein the obtaining, an island map where the inner boundary line is located, comprises:
obtaining the target signal emitted by a target electronic tag set on the inner boundary line;
obtaining coordinate information of the target electronic tag as a starting point;
traveling, based on the target signal, along the inner boundary line, until reaching the starting point again, obtaining a closed-loop path, and generating the island map.

19. The boundary line identification method as claimed in claim 17, wherein the updating of the preset travel path comprises:
obtaining, based on the preset travel direction, at least one estimated path along the boundary line of the island map;
determining, based on an estimated travel distance or an estimated travel smoothness of the estimated path, to update the preset travel path.

20. The boundary line identification method as claimed in claim 11, wherein the method further comprises:
obtaining, in condition of determining the current boundary line as the inner boundary line and a current device being in an operation mode, an operation path;
determining, based on the operation path, a travel path for leaving the inner boundary line.

21. An intelligent device, wherein the intelligent device comprises a detection module and a marking module;
the detection module is configured to detect a target signal, the target signal is generated from a boundary line of a working area, and the boundary line comprises an inner boundary line and an outer boundary line;
the marking module is configured to obtain identity information embedded in the target signal, a database stores at least one identity information of the inner boundary line, the identity information embedded in the target signal is configured to indicate whether a current boundary line belongs to the outer boundary line or the inner boundary line of the working area, the target signal is emitted by an electronic tag on the current boundary line, and the electronic tag is at least disposed on the inner boundary line;
in condition of not finding the identity information of the inner boundary line or the outer boundary line in the database that matches with the identity information embedded in the target signal, the current boundary line is marked as the inner boundary line and the database is updated.

22. The intelligent device as claimed in claim 21, wherein in condition of both of the inner boundary line and the outer boundary line having the electronic tag disposed thereon, the marking module is further configured to
traverse along the outer boundary line of the working area;
parse, in condition of detecting the target signal emitted by the electronic tag disposed on the outer boundary line, the target signal to obtain the identity information of the outer boundary line and store the identity information of the outer boundary line in the database;
detect, based on the database that stores the identity information of the outer boundary line, the target signal of the electronic tag again;
parse the target signal to obtain the identity information of the current boundary line, and determine, in condition of the identity information of the current boundary line being different from that of the outer boundary line being stored in the database, the current boundary line as the inner boundary line.

23. The intelligent device as claimed in claim 21, wherein in condition of only the inner boundary line having the electronic tag disposed thereon, the marking module is further configured to
parse, in condition of detecting the target signal emitted by the electronic tag, the target signal to obtain the identity information of the current boundary line;
determine, in condition of not finding the identity information of the current boundary line in the database, the current boundary line as the inner boundary line.

24. The intelligent device as claimed in claim 21, wherein, before marking the current boundary line as the inner boundary line, the marking module is further configured to
obtain, in condition of not finding the identity information of the inner boundary line in the database that matches with the identify information embedded in the target signal and not finding the identity information of the outer boundary line that matches with the identity information embedded in the target signal, a current travel direction of a target device, wherein the current travel direction refers to a direction of travel after moving a preset angle from a position of a current electronic tag, and the database stores at least one piece of identity information of the outer boundary line;
determine, based on the current travel direction, whether the current boundary line is the inner boundary line.

25. The intelligent device as claimed in claim 21, wherein the marking module is further configured to
obtain, in condition of not detecting the target signal emitted by the electronic tag on the current boundary line, a current travel direction of a target device, wherein the current travel direction refers to a direction of travel after moving a preset angle from a position of a current electronic tag;
determine, based on the current travel direction, whether the current boundary line is the inner boundary line.

26. The intelligent device as claimed in claim 24, wherein the marking module is further configured to
obtain a preset travel direction of the target device;
determine, in condition of the preset travel direction of the target device being consistent with the current travel direction, the current boundary line as the outer boundary line;
otherwise, determine the current boundary line as the inner boundary line.

27. The intelligent device as claimed in claim 21, wherein the marking module is further configured to
obtain, in condition of determining the current boundary line being the inner boundary line and a current device being not in an operation mode, an island map where the inner boundary line is located, a preset travel direction, and a preset travel path;
obtain, based on the preset travel direction, a path along a boundary line of the island map and updating the preset travel path.

28. The intelligent device as claimed in claim 27, wherein the marking module is further configured to
obtain the target signal emitted by a target electronic tag set on the inner boundary line;
obtain coordinate information of the target electronic tag as a starting point;
travel, based on the target signal, along the inner boundary line, until reaching the starting point again, obtain a closed-loop path, and generate the island map.

29. The intelligent device as claimed in claim 27, wherein the marking module is further configured to
obtain, based on the preset travel direction, at least one estimated path along the boundary line of the island map;
determine, based on an estimated travel distance or an estimated travel smoothness of the estimated path, to update the preset travel path.

30. A non-transitory computer readable storage medium, wherein the non-transitory computer readable storage medium stores an instruction, which when executed by a processor, implements the method of
detecting a target signal, wherein the target signal is generated from a boundary line of a working area, and the boundary line comprises an inner boundary line and an outer boundary line;
obtaining identity information embedded in the target signal from a database, wherein the database stores at least one identity information of the inner boundary line, the identity information embedded in the target signal is configured to indicate whether a current boundary line belongs to the outer boundary line or the inner boundary line of the working area, the target signal is emitted by an electronic tag on the current boundary line, and the electronic tag is at least disposed on the inner boundary line;
marking, in condition of not finding the identity information of the inner boundary line or the outer boundary line in the database that matches with the identity information embedded in the target signal, the current boundary line as the inner boundary line.
